(19) United States
(12) Patent Application Publication
(10) Pub. No.: US 2025/0350144 A1
(43) Pub. Date: Nov. 13, 2025

(54) SYSTEMS FOR AND METHODS OF OPERATIONAL METERING FOR OPERATIONAL METERING FOR A DISTRIBUTED ENERGY SYSTEM

(71) Applicant: KRAKEN TECHNOLOGIES LIMITED, London (GB)

(72) Inventors: Dan WILLIAMS, Manchester (GB); Paul JACKSON, Stockport (GB)

(73) Assignee: KRAKEN TECHNOLOGIES LIMITED, London (GB)

(21) Appl. No.: 18/860,224

(22) PCT Filed: Mar. 16, 2023
(86) PCT No.: PCT/GB2023/050630

§ 371 Date: Oct. 25, 2024

(30) Foreign Application Priority Data
Apr. 26, 2022 (GB) 2206084.2

(51) Int. Cl. H02J 13/00; H02J 3/38

(52) U.S. Cl. CPC H02J 13/00002; H02J 3/38; H02J 13/00006

(57) ABSTRACT

The present disclosure relates to a computer-implemented method of operational metering for a distributed energy system arranged to provide energy to a power grid, the distributed energy system comprising a plurality of energy provision devices configured to output stored energy and an operation metering module configured to control operation of the plurality of energy provision devices. the method being performed by the operation metering module and comprising: receiving raw data from the plurality of energy provision devices, the raw data comprising operational data of each energy provision device; processing the raw data to remove a portion of the operational data of each energy provision device; selecting representative data from the processed raw data for each energy provision device representative of a state of each energy provision device; and aggregating the representative data of each energy provision device into an aggregated data package and sending the aggregated data to the power grid.

### FIELD OF THE INVENTION

The present disclosure relates to distributed energy systems. In particular, the present disclosure relates to operational metering for distributed energy systems.

### BACKGROUND

A national grid (power grid) requires operational metering data from assets, herein energy provision devices, that contribute to electricity provision to maintain the balance of the service provided by the grid. Herein, “energy provision devices” refer to any devices capable of providing and sustaining the provision of energy/power for a required duration of time. For example, energy provision devices may include batteries, other forms of domestic and industrial energy storage devices, various types of generators, various types of demand assets e.g., electrolysers, heat pumps, industrial machines, etc.

A power grid uses the Balancing Mechanism (BM) to balance electricity supply and demand in real time. When electricity generation and consumption are not in balance, the grid uses the BM to purchase available power from participating assets to correct the imbalance. As such, the grid requires operational data such as active or available power from the participating assets, and the data must be received in real time for the data to be relevant.

Balancing Mechanism Units (BMUs) are used as units of trade within the Balancing Mechanism. A BMU is considered the smallest grouping that can independently trade with the grid. Energy produced or consumed by any devices belonging to a BMU is accredited to that BMU. Conventionally, for energy production, each BMU comprises a single generating unit, and for energy consumption, a collection of consumption meters. For an industrial-scale generator capable of producing enough energy to trade as a single BMU, operational data can be streamed directly from the asset to the data concentrator service of the power grid.

However, smaller-scale assets such as domestic heat pumps, domestic solar panels, electric vehicle batteries, etc. cannot provide enough energy individually to trade independently. Thus, distributed small-scale assets located in different geographical locations are grouped together to form a virtual asset to trade as a virtual BMU. In such an arrangement, when delivering operational data of the virtual BMU to the power grid, operational data from each individual physical asset must first be aggregated, and so new challenges are introduced that are not present in conventional metering delivery where there is a one-to-one mapping between a physical asset and a BMU as viewed by the power grid.

For a virtual BMU, each physical asset first consumes or produces electricity, then operational data from each asset is collected, the collected data aggregated together, and then the aggregated data is delivered to the power grid. In order for the aggregated operational data to be relevant and usable by the grid, latency must be minimised while maintaining the cost of processing resources required for the aggregation process at a level sufficiently low such that the service does not become unprofitable to operate for asset operators and the service provider.

It is therefore desirable to provide improved methods of and systems for operational metering for a distributed energy system.

### SUMMARY

In view of the foregoing, the present technology provides a computer-implemented method of operational metering for a distributed energy system arranged to provide energy to a power grid, the distributed energy system comprising a plurality of energy provision devices configured to output stored energy and an operation metering module configured to control operation of the plurality of energy provision devices, the method being performed by the operation metering module and comprising: receiving raw data from the plurality of energy provision devices, the raw data comprising operational data of each energy provision device; processing the raw data to remove a portion of the operational data of each energy provision device; selecting representative data from the processed raw data for each energy provision device representative of a state of each energy provision device; and aggregating the representative data of each energy provision device into an aggregated data package and sending the aggregated data to the power grid.

According to embodiments of the present technology, raw operational data from a plurality of energy provision devices of a distributed energy system is processed to remove a portion of the raw data that is deemed irrelevant or not immediately needed for operation assessment, then representative data from each energy provision device is selected from the processed data to further reduce the amount of data before the much-reduced operational data is aggregated and sent to the power grid. Herein, an energy provision device may include any small-scale energy storage and/or generation devices such as electric car batteries, energy storage devices for renewable energy such as solar and wind power, small-scale power generators, etc. By first filtering out data that is not required by the power grid then selecting only data that is representative of the current state of each energy provision device before aggregating the data, the amount of data needed to be processed for aggregation is vastly reduced and as such, processing resource requirement and processing time can both be reduced. Moreover, by improving the processing time needed to aggregate data and reducing the amount of aggregated data to be sent to the power grid, the latency between when operational data was taken and when the data reaches the power grid can also be reduced.

In some embodiments, the method may further comprise: receiving a service request from the power grid, the service request being generated to request energy provision service at a level determined based on the aggregated data package; and outputting instructions to one or more of the plurality of energy provision devices in response to the service request to instruct the one or more of the plurality of energy provision devices to output stored energy to meet the requested level of energy provision service. Using the aggregated data, the power grid is able to assess the combined operational status of the plurality of energy provision devices in the distributed energy system to determine what level of energy provision service can be expected from the distributed energy system, and request energy provision service from a virtual BMU accordingly. As such, by reducing the amount of irrelevant operational data, the aggregated data generated and sent by the operation metering module helps to ensure that a request for service received by the distributed energy system matches the capacity of the system.

In some embodiments, the removed portion of the raw data may comprise operational data not used by the power grid when determining the level of energy provision service. For example, the removed portion may include older operational data, e.g. over the length of time when an energy provision device has been out of service, temperature measurements, etc.

In some embodiments, the method may further comprise storing the removed portion of the raw data to be analysed. While the removed portion contains data that is not required by the power grid, it is useful to analyse this data, for example, to understand how each energy provision device has been performing and, for example, to determine whether any device has been out of service or should be excluded from service, e.g. if a device is overheating or is below a specified minimum level of state of charge (SoC).

In some embodiments, the method may further comprise monitoring data received at and/or being processed by the operation metering module by applying one or more operational rules to the data. The monitoring may be performed at any stage on the raw data, the processed data, the representative data, the removed portion of the raw data, and/or processed data that has not been selected as the representative data. The monitoring may be performed simultaneously with the aggregation processing, or, preferably, performed outside of the aggregation processing pipeline, optionally at a slower processing speed.

In some embodiments, the one or more operational rules may be applied to the data to identify an anomaly.

In some embodiments, the method may further comprise excluding an energy provision device from the plurality of energy provision devices when an anomaly is identified with the device. For example, an anomaly may be a device operating at a temperature exceeding a specified maximum temperature.

In some embodiments, the raw data received from the plurality of energy provision devices may comprise a plurality of messages, each message may comprise a plurality of readings, and the method may further comprise, after processing the raw data to remove a portion of the operational data of each energy provision device, dividing each message in the processed raw data into the plurality of readings. The plurality of readings in a message from a device may relate to different device parameters, for example operating temperature, state of charge, active or available power, etc., and the plurality of readings may include readings of one or more of these parameters at different time, e.g. multiple readings may be taken every second, or older readings may be included if the device has been out of service for a period of time. By dividing each message into a plurality of readings, it is possible to filter, select, manipulate or otherwise process each reading independently.

In some embodiments, the plurality of readings may comprise one or more temperature measurements, one or more state of charge measurements, one or more available power measurements, historical data, or any combination thereof.

In some embodiments, the method may further comprise generating a data file for each of the plurality of readings, wherein the data file for each of the plurality of readings may comprise the reading and metadata, the metadata comprising a timestamp and a unique identification for the reading. The inclusion of metadata allows additional information associated with each reading to be included, e.g. to enable readings to be sorted in a chronological order, to uniquely identify each reading, etc.

In some embodiments, the unique identification for the reading may comprise a device identification identifying the energy provision device from which the reading is taken and a reading identification identifying the reading from the plurality of readings in a message.

In some embodiments, the representative data of each energy provision device may comprise the most recent reading amongst the plurality of readings, a highest reading amongst the plurality of readings, or an average of the plurality of readings.

Another aspect of the present technology provides a computer-readable storage medium comprising machine-readable code, which, when executed by a processor, causes the processor to perform the method as described above.

A further aspect of the present technology provides an operation metering system for operational metering for a distributed energy system arranged to provide energy to a power grid, the distributed energy system comprising a plurality of energy provision devices configured to output stored energy, the operation metering system comprising: a communication module configured to communicate with the power grid; and a processing unit comprising at least one processor and memory storing machine-readable code which, when executed by the at least one processor, causes the at least one processor to: receive raw data from the plurality of energy provision devices, the raw data comprising operational data of each energy provision device; process the raw data to remove a portion of the operational data of each energy provision device; select representative data from the processed raw data for each energy provision device representative of a state of each energy provision device; and aggregate the representative data of each energy provision device into an aggregated data package and sending the aggregated data to the power grid.

In some embodiments, the operation metering system may comprise a plurality of processing units configured in a distributed processing system, and wherein the operation metering system is scalable based on a number of energy provision devices in the distributed energy system. In an arrangement where the plurality of energy provision devices is operated by different operators in different locations, not all of the plurality of energy provision devices in the distributed energy system may be available for energy provision at all time or at the same time. As such, processing load may vary depending on the number of energy provision devices available at a given time. Thus, the present decentralised approach ensures that resources are only employed by the operation metering system when they are required, and the system can be scaled up if the processing load increases.

A yet further aspect of the present technology provides a distributed energy system for providing energy to a power grid, comprising: a plurality of energy provision devices each configured to output stored energy; and an operation metering system as described above.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

Embodiments will now be described, with reference to the accompanying drawings, in which:

FIG. 1 shows an exemplary operation metering system; and

FIG. 2 schematically shows an exemplary distributed energy system arranged to provide energy to a power grid.

### DETAILED DESCRIPTION

Service providers currently offer systems for, and methods of, aggregating data across multiple assets wherein aggregation of data is performed by a centralised server. However, due to the large amount of data that needs to be processed, the act of sampling the data in order to calculate aggregate readings inevitably introduces latency. So as to reduce the overall latency, latency at other stages of the process must be reduced and limited, which often leads to a need to allocate more processing resources (and therefore increasing costs). As such, it is challenging for service providers to perform data aggregation with low latency at low cost, and so there is often a trade-off between low latency and high cost, or slow but low cost.

In view of the foregoing, the present technology provides methods of and systems for operational metering for a distributed energy system that comprises a plurality of energy provision devices. The present approach employs priority-based routing of different data type produced by the plurality of devices from source all the way through to aggregation. This enables important information to be at the front of a processing pipeline at every step of the processing, while processing of less important information and other non-time-critical processing may be performed at a slower pace or at a later stage.

The present approach may further include deduplication of data amongst the prioritised data to identify data that is deemed not useful to the final aggregated data (e.g. the data is not expected to change the output result, e.g. older data) before the data goes to aggregation, such that the aggregation process becomes more efficient by reducing the time and resources drained by processing data that is deemed not useful.

Moreover, the present approach may further monitor the plurality of energy provision devices in real time, such that if there is an issue with an individual device, a status associated with the device may be updated in real time to reflect the issue. Then, status information for the plurality of devices is updated and presented to the aggregation process, which uses the status information to determine which device(s) should be included (or excluded) as part of the aggregation. The inclusion of status information associated with each device means that operational data from devices that are offline or otherwise not available for service can be excluded from the aggregation processing, thus further reducing the amount of data that needs to be processed.

While in conventional approaches a centralised server is employed to perform aggregation processing for a plurality of devices, the present approach may be implemented in a distributed system comprising a plurality of interconnected processing units. Since individual energy provision devices are often in different locations and operated by different owners, the number of devises participating in the distributed energy system fluctuates from time to time. By employing a distributed processing system, it is possible to scale the processing system up or down as processing load increases or decreases with the number of devices, and ensures that processing resources are only used as required.

The present approach enables assets such as electric vehicles and other small-scale energy storage or generators to group together and deliver an energy provision service that conventionally is only possible for larger-scale more expensive assets such as industrial-scale batteries and gas peaking plants. Thus, through the present approach, grid services are made accessible to smaller distributed assets, which in turn provides increased flexibility to the power grid.

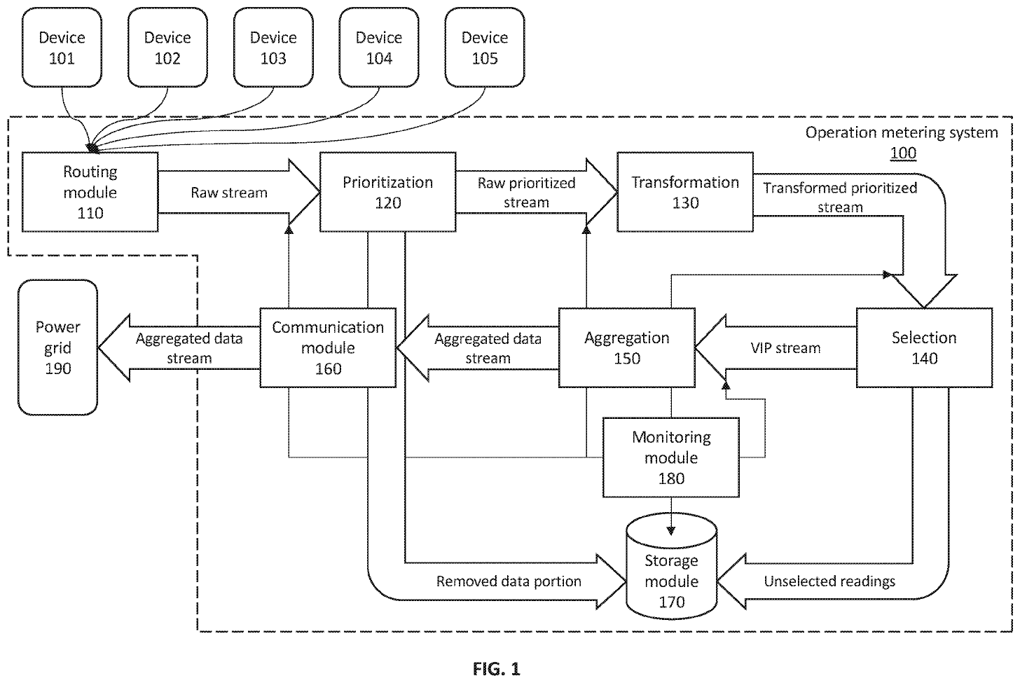

An implementation example will now be described with reference to FIG. 1, in which a distributed energy system is shown comprising an operation metering system 100 and a plurality of energy provision devices 101, 102, 103, 104 and 105 arranged to provide energy (electricity) to a power grid 190. The plurality of energy provision devices 101-105 may for example includes electric vehicle batteries, domestic or small-scale photovoltaic cells, wind turbines, hydropower generators, domestic or small-scale battery energy storage system (e.g. lithium ion batteries) e.g. for solar panels, wind turbine, hydropower, etc.

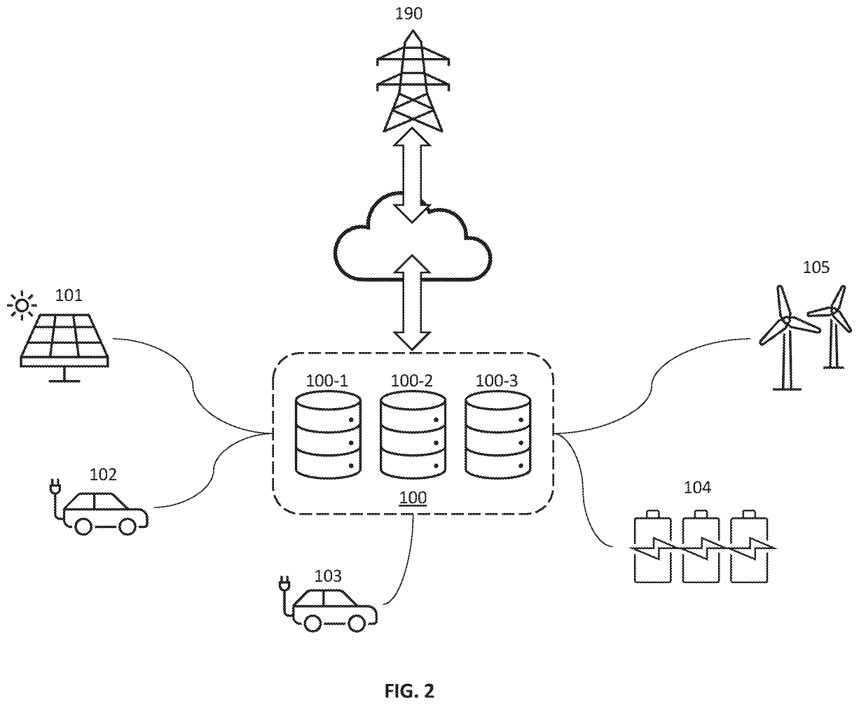

The operation metering system 100 may be implemented in a single processing unit (e.g. a server) comprising at least one processor, or, in the present embodiment, as shown in FIG. 2, in a distributed processing system comprising a plurality of processing units 100-1, 100-2, 100-3. Implementing the operation metering system 100 in a distributed processing system allows the operation metering system 100 to be scalable according to processing load. For example, the number of processing units employed by the operation metering system 100 may be increased or reduced proportionate to the number of active energy provision devices in the distributed energy system.

In the present embodiment, the operation metering system 100 comprises a routing module 110 (e.g. IoT MQTT broker) configured to receive operational data from the plurality of energy provision devices 101-105 and forward the received data to one or more processing units in a series of messages. In an example, one message is received from each device 101-105 every second. In other examples, messages may be received from each device 101-105 more or less frequently, as desired. There may be instances when messages are not received from a device for a period of time, for example, if a device is offline or taken out of service (e.g. due to a fault or otherwise not available). Each message may include a plurality of readings obtained at one of the devices 101-105 relating to different aspects of operation of the device, for example operating temperature, state of charge, available power, operation status (e.g. online, offline, available/not available for service), etc., and readings obtained at multiple time points. In an example, each message may include 20 readings, but more or fewer readings are possible as desire.

The messages received from the devices 101-105 forms a raw data stream which first goes through a prioritization process 120, where data that is not of interest to the power grid 190 (e.g. data that is not relevant to the Balancing Mechanism) is filtered out or removed. The removed data portion may simply be discarded if desired, but in the present embodiment, the removed data portion is sent to a storage module 170 to be analysed by a monitoring module 180.

The prioritized data (e.g. available power) forms a raw prioritized stream which goes through a transformation process 130, where the prioritized data is transformed to telemetry data and timestamped. In particular, each message is separated into individual readings (e.g. 20 readings), each reading forming an individual data file comprising metadata such as a timestamp and a unique identification e.g. comprising a device identifier and a reading identifier.

A selection or reduction process 140 is then performed on the transformed prioritized data to further reduce the amount of data before the data is aggregated. In particular, of the plurality of individual readings from each message, one or more, but not all, reading (representative data) is selected that is representative of the current status of the device associated with the message. In the present embodiment, one reading from each message is selected as the representative data from that message (or for the device associated with that message). In other words, for each device in the present example, the amount of data to be processed for aggregation is reduced from 20 readings per second to one reading per second. In order for the data to be representative of the current status of a device, different selection criteria may be used. In an example, of the 20 readings in a message, the most recent reading (e.g. based on a comparison of timestamps) is selected. In another example, of the 20 readings in a message, the highest or lowest reading is selected. In a further example, of the 20 readings in a message, a reading that represents an average value is selected. Other selection criteria may be used as desired. Readings that have not been selected as representative data may simply be discarded. Alternatively, in the present embodiment, readings that are not representative data are stored in the storage module 170 to be analysed by the monitoring module 180.

The representative data (selected readings) proceeds to an aggregation process 150 in a VIP stream, where representative data from the plurality of devices 101-105 is aggregated. The aggregation process 150 may comprise a summation of the representative reading from each device, or an averaging of all representative readings from all devices. The aggregated data is then transmitted to the power grid 190 through a communication module 160.

Data that has been removed during prioritization 120 and data not selected as representative data during selection 140 are stored in the storage module 170, so that the data may be analysed by the monitoring module 180 outside of the aggregation processing pipeline. In doing so, the amount of data that needs to be processed for aggregation is greatly reduced, and aggregation processing is streamlined by maximising available computing time on time-critical aggregation processing. In an example, a latency of no more than 5 seconds can be achieved through the present embodiment.

Monitoring of data by the monitoring module 180 may be performed in real time. In addition to data stored in the storage module 170, the monitoring module 180 may also monitor data at different stages of the aggregation processing, if desired, for example to identify any anomaly that may render data from a particular device or in a particular message unsuitable for aggregation, e.g. if a device is overheating or otherwise faulty or unavailable. The monitoring module 180 may be configured to apply one or more operational rules to the data being monitored/analysed in order to determine a status of a device (e.g. online/offline, available/not available) and/or to identify one or more anomalies in the data.

As will be appreciated by one skilled in the art, the present techniques may be embodied as a system, method or computer program product. Accordingly, the present techniques may take the form of an entirely hardware embodiment, an entirely software embodiment, or an embodiment combining software and hardware.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high-speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

The examples and conditional language recited herein are intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its scope as defined by the appended claims.

Furthermore, as an aid to understanding, the above description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to limit the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labelled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

It will be clear to one skilled in the art that many improvements and modifications can be made to the foregoing exemplary embodiments without departing from the scope of the present techniques.

1. A computer-implemented method of operational metering for a distributed energy system arranged to provide energy to a power grid, the distributed energy system comprising a plurality of energy provision devices configured to output stored energy and an operation metering module configured to control operation of the plurality of energy provision devices, the method being performed by the operation metering module and comprising:
receiving raw data from the plurality of energy provision devices, the raw data comprising operational data of each energy provision device;
processing the raw data to remove a portion of the operational data of each energy provision device;
selecting representative data from the processed raw data for each energy provision device representative of a state of each energy provision device; and
aggregating the representative data of each energy provision device into an aggregated data package and sending the aggregated data to the power grid.

2. The method of claim 1, further comprising:
receiving a service request from the power grid, the service request being generated to request energy provision service at a level determined based on the aggregated data package; and
outputting instructions to one or more of the plurality of energy provision devices in response to the service request to instruct the one or more of the plurality of energy provision devices to output stored energy to meet the requested level of energy provision service.

3. The method of claim 2, wherein the removed portion of the raw data comprises operational data not used by the power grid when determining the level of energy provision service.

4. The method of claim 3, further comprising storing the removed portion of the raw data to be analysed.

5. The method of claim 1, further comprising monitoring data received at and/or being processed by the operation metering module by applying one or more operational rules to the data.

6. The method of claim 5, wherein the one or more operational rules are applied to the data to identify an anomaly.

7. The method of claim 5, further comprising excluding an energy provision device from the plurality of energy provision devices when an anomaly is identified with the device.

8. The method of claim 1, wherein the raw data received from the plurality of energy provision devices comprises a plurality of messages, each message comprising a plurality of readings, and the method further comprises, after processing the raw data to remove a portion of the operational data of each energy provision device, dividing each message in the processed raw data into the plurality of readings.

9. The method of claim 8, wherein the plurality of readings comprises one or more temperature measurements, one or more state of charge measurements, one or more available power measurements, historical data, or any combination thereof.

10. The method of claim 8, further comprising generating a data file for each of the plurality of readings, wherein the data file for each of the plurality of readings comprises the reading and metadata, the metadata comprising a timestamp, a unique identification for the reading.

11. The method of claim 10, wherein the unique identification for the reading comprises a device identification identifying the energy provision device from which the reading is taken and a reading identification identifying the reading from the plurality of readings.

12. The method of any of claim 8, wherein the representative data of each energy provision device comprises the most recent reading amongst the plurality of readings, a highest reading amongst the plurality of readings, or an average of the plurality of readings.

13. A non-transitory computer-readable medium comprising machine-readable code which, when executed by a processor, causes the processor to perform a method of operational metering for a distributed energy system arranged to provide energy to a power grid, the distributed energy system comprising a plurality of energy provision devices configured to output stored energy and an operation metering module configured to control operation of the plurality of energy provision devices, the machine-readable code when executed causing the operation metering module to perform operations including:
receiving raw data from the plurality of energy provision devices, the raw data comprising operational data of each energy provision device;
processing the raw data to remove a portion of the operational data of each energy provision device;
selecting representative data from the processed raw data for each energy provision device representative of a state of each energy provision device; and
aggregating the representative data of each energy provision device into an aggregated data package and sending the aggregated data to the power grid.

14. An operation metering system for operational metering for a distributed energy system arranged to provide energy to a power grid, the distributed energy system comprising a plurality of energy provision devices configured to output stored energy, the operation metering system comprising:
a communication module (160) configured to communicate with the power grid; and
a processing unit comprising at least one processor and memory storing machine-readable code which, when executed by the at least one processor, causes the at least one processor to:
receive raw data from the plurality of energy provision devices, the raw data comprising operational data of each energy provision device;
process the raw data to remove a portion of the operational data of each energy provision device;
select representative data from the processed raw data for each energy provision device representative of a state of each energy provision device; and
aggregate the representative data of each energy provision device into an aggregated data package and sending the aggregated data to the power grid.

15. The system of claim 14, comprising a plurality of processing units configured in a distributed processing system, and wherein the operation metering system is scalable based on a number of energy provision devices in the distributed energy system.

16. The system of claim 14, wherein execution of the machine-readable code by the at least one processor further causes the at least one processor to:
receive a service request from the power grid, the service request being generated to request energy provision service at a level determined based on the aggregated data package; and
output instructions to one or more of the plurality of energy provision devices in response to the service request to instruct the one or more of the plurality of energy provision devices to output stored energy to meet the requested level of energy provision service.

17. The system of any of claim 14, further comprising a monitoring module (180) configured to monitor data received at and/or being processed by the processing unit by applying one or more operational rules to the data.

18. The system of claim 17, wherein the one or more operational rules are applied to the data to identify an anomaly, wherein execution of the machine-readable code by the at least one processor further causes the at least one processor to exclude an energy provision device from the plurality of energy provision devices when an anomaly is identified with the device.

19. The system of claim 14, further comprising a routing module (110) configured to receive the raw data from the plurality of energy provision devices and to forward the received raw data to the processing unit.

20. The system of claim 14, further comprising a storage module (170) configured to store the removed portion of the raw data to be analysed.

21-25. (canceled)
